(19) United States
(12) Patent Application Publication
(10) Pub. No.: US 2004/0263912 A1
(43) Pub. Date: Dec. 30, 2004

(54) Method of making hidden patterns and characters

(75) Inventor: Chin-Piao Weng, Taipei (TW)

Correspondence Address: TROXELL LAW OFFICE PLLC, SUITE 1404, 5205 LEESBURG PIKE, FALLS CHURCH, VA, 22041, US

(73) Assignee: Cheng May Enterprise Co., Ltd.

(21) Appl. No.: 10/867,691

(22) Filed: Jun. 16, 2004

(30) Foreign Application Priority Data
Jun. 27, 2003 (TW) 092117592

(51) Int. Cl. H04N 1/50; B41C 1/00; H04N 1/56

(52) U.S. Cl. 358/3.28; 283/902; 358/3.29; 358/530

(57) ABSTRACT

The present invention is to disclose a method of hidden patterns and characters, which comprises the following steps of: 1. finishing an original document after a printing design is formed; 2. transforming the original document into a digital document; and 3. performing an anti-counterfeiting treatment to the digital document; 3-1. single-selecting a color plate from a design pattern file of the digital document; 3-2. forming a filter file of the digital document; 3-3. performing a graphic arts lining treatment, which comprises: aligning and overlapping the filter file and the selected color plate and transforming a pattern of the color plate with a darkness/lightness ratio into a linear filling pattern with a corresponding thickness/thinness ratio; and 3-4. performing an embossed pattern line deforming treatment on an anti-counterfeiting pattern to form an angle/shift deformation on an overlapped line between the linear filling pattern and the anti-counterfeiting pattern so that the deformed linear filling pattern is an anti-counterfeiting product. Accordingly, the present invention is provided with excellent anti-counterfeiting effect.

### FIELD OF THE INVENTION

The present invention relates to a method of making of hidden patterns and characters, and more particularly, to an anti-counterfeiting product which is formed by a graphic arts lining treatment, in which the filter file is aligned and overlapped with the selected color plate and a pattern of the color plate with a darkness/lightness ratio is transformed into a linear filling pattern with a corresponding thickness/thinness ratio; and an embossed pattern line deforming treatment, thereby the anti-counterfeiting product is provided with excellent anti-counterfeiting effect which is suitable for valuable paper, card, every kind of tag, poster, transfer film, and so on.

### BACKGROUND OF THE INVENTION

Generally speaking, referring to FIG. 1, a conventional printing method comprises the following steps: 1. A step of finishing an original document 2 is performed after a printing design 1 is formed. 2. The original document 2 is transformed into a digital document 4 for producing a film 5, which can be formed alternatively by a step of forming the film by photography 3. 3. A plate exposure step 6, a plate washing step 7, and an on-press printing step 8 are performed sequentially on the film 5 to form a printing product. However, even the printing product with exquisite pattern can be formed according to the conventional method, it is still does not satisfy user requirements due to lack of anti-counterfeiting function.

### SUMMARY OF THE INVENTION

Accordingly, one aspect of the present invention is to provide a manufacturing method for hiding patterns and characters. A step of finishing an original document is performed after a printing design is formed. The original document is transformed into a digital document. An anti-counterfeiting treatment is performed on the digital document by a graphic arts lining treatment which comprises of aligning and overlapping the filter file and the selected color plate and thereafter transforming a pattern of the color plate with a darkness/lightness ratio into a linear filling pattern with a corresponding thickness/thinness ratio, and an embossed pattern line deforming treatment which is performed on an anti-counterfeiting pattern to form an anti-counterfeiting product with excellent anti-counterfeiting effect for increased practicability as a whole and security.

According to the aforementioned aspect of the present invention, there is provided a method of hidden patterns and characters, which comprises the following steps of: 1. finishing an original document after a printing design is formed; 2. transforming the printed original document into a digital document; and 3. performing an anti-counterfeiting treatment on the digital document; 3-1. single-selecting a color plate from a design pattern file of the digital document; 3-2. forming a filter file of the digital document; 3-3. performing a graphic arts lining treatment, which comprises of: aligning and overlapping the filter file and the selected color plate and transforming a pattern of the color plate with a darkness/lightness ratio into a linear filling pattern with a corresponding thickness/thinness ratio; 3-4. performing an embossed pattern line deforming treatment on an anti-counterfeiting pattern to form an angle/shift deformation on an overlapped line between the linear filling pattern and the anti-counterfeiting pattern so that the deformed linear filling pattern is an anti-counterfeiting product. Accordingly, the present invention provides excellent anti-counterfeiting effect.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing a manufacturing process of the prior art.

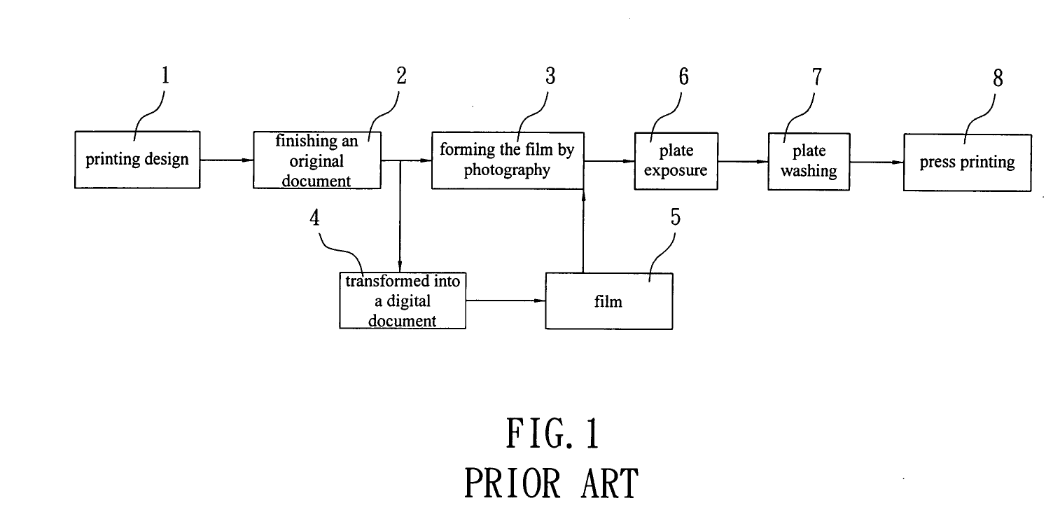

FIG. 2 is a schematic diagram showing a manufacturing process of the present invention.

FIG. 3 is a schematic diagram showing an anti-counterfeiting treating process of the present invention.

FIG. 4 is a schematic diagram showing the outward appearance of a filter and a product (tag shown) of the present invention.

FIG. 5 is a schematic, partial enlarged view showing the filter of the present invention.

FIG. 6 is a schematic diagram showing of the present invention in use.

### DETAILED DESCRIPTION OF THE PREFERRED EMBODIMENT

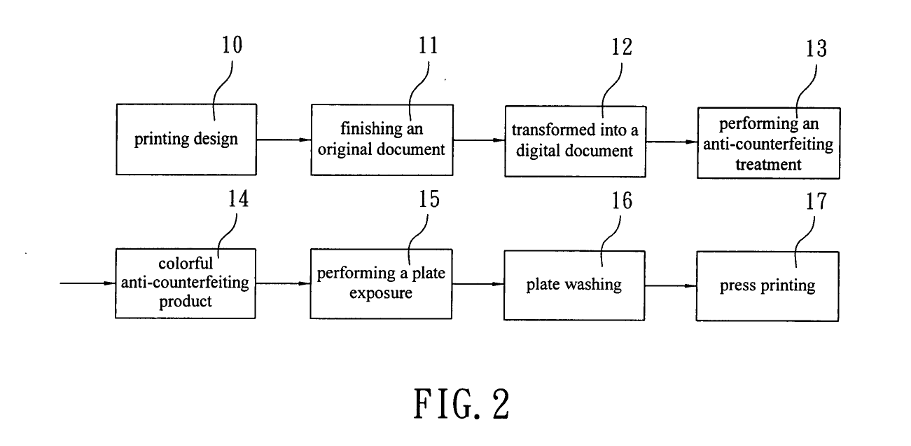

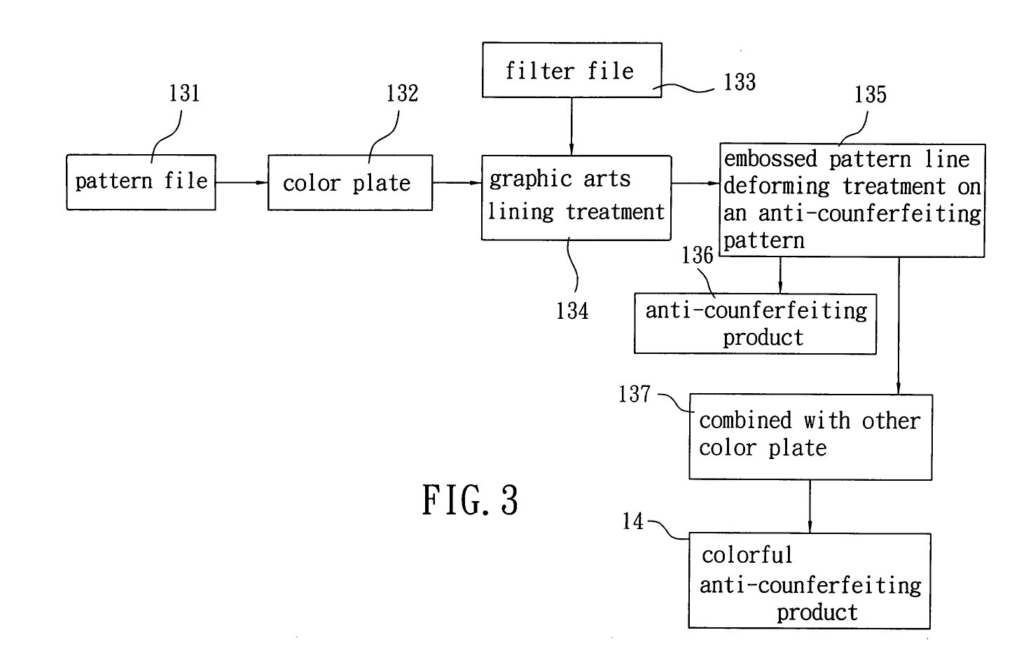

Please refer to FIG. 2 and FIG. 3, the method of hidden patterns and characters of the present invention comprises the following steps:

1. finishing an original document 11 after a printing design 10 is formed;

2. transforming the printed original document 11 into a digital document 12; and

3. performing an anti-counterfeiting treatment 13 to the digital document 12;

3-1. single-selecting a color plate 132 from a design pattern file 131 of the digital document 12;

3-2. forming a filter file 133 of the digital document 12: providing a rectangular frame with a size equal to that of the color plate selected singly from the design pattern file, filling the rectangular frame with a plurality of straight lines that are arranged parallel to each other in equal distance according to a filling angle corresponded to a dot angle so as to constitute the filter file;

3-3. performing a graphic arts lining treatment 134: aligning and overlapping the filter file and the selected color plate and performing a step of graphic arts function calculating, wherein a pattern of the color plate with a darkness/lightness ratio is transformed into a linear filling pattern with a corresponding thickness/thinness ratio;

3-4. performing an embossed pattern line deforming treatment on an anti-counterfeiting pattern 135: placing the anti-counterfeiting pattern, for example, pattern, character, and so on, on the linear filling pattern and performing an embossing treatment, in which an embossing angle is equal to a filling angle plus 90 degrees; meanwhile an angle/shift deformation is formed on an overlapped line between the linear filling pattern and the anti-counterfeiting pattern so that the deformed linear filling pattern is an anti-counterfeiting product 136; (The anti-counterfeiting product 136 is an anti-counterfeiting color plate, the anti-counterfeiting color plate is combined with other color plate(s) 137 of the design pattern file to accomplish the colorful anti-counterfeiting product 14.)

4. performing a plate exposure step 15, a plate washing step 16, and an on-press printing step 17 sequentially to accomplish the anti-counterfeiting product 136 (or the colorful anti-counterfeiting product 14).

Please refer to FIG. 2 and FIG. 3, the key feature of the present invention is that the digital document 12 is treated with the anti-counterfeiting treatment 13 according to the above method, wherein the anti-counterfeiting treatment 13 comprises single-selecting a color plate 132 from a design pattern file 131 of the digital document 12, forming a filter file 133 of the digital document 12, performing a graphic arts lining treatment 134 for aligning and overlapping the filter file and the selected color plate to perform a step of graphic arts function calculating, wherein a pattern of the color plate with a darkness/lightness ratio is transformed into a linear filling pattern with a corresponding thickness/thinness ratio, and performing an embossed pattern line deforming treatment on an anti-counterfeiting pattern 135 for placing the anti-counterfeiting pattern on the linear filling pattern and performing an embossing treatment, wherein an angle/shift deformation is formed on an overlapped line between the linear filling pattern and the anti-counterfeiting pattern so that the deformed linear filling pattern is an anti-counterfeiting product 136. Accordingly, the present invention is suitable for performing the embossed pattern line deforming treatment on different kinds of anti-counterfeiting pattern to form the anti-counterfeiting product 136, which can be film, file, printing, printing plate, and so on, thereby the anti-counterfeiting pattern cannot be identified by naked eyes so as to be provided with excellent anti-counterfeiting effect for practicability as a whole and security.

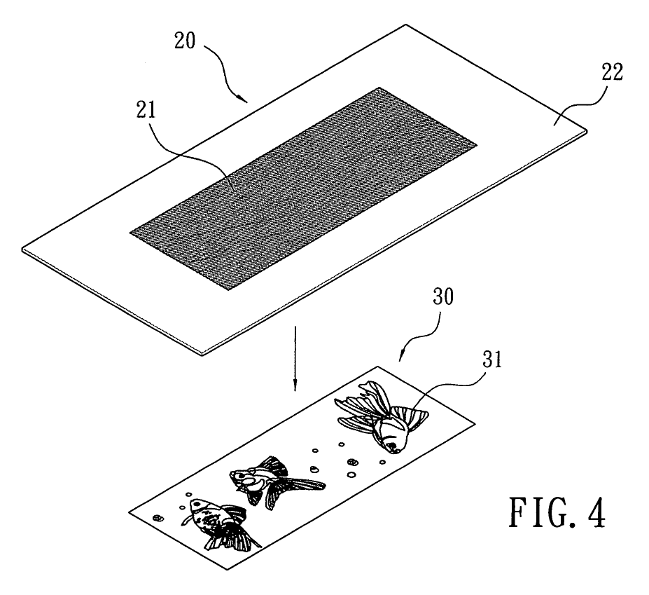

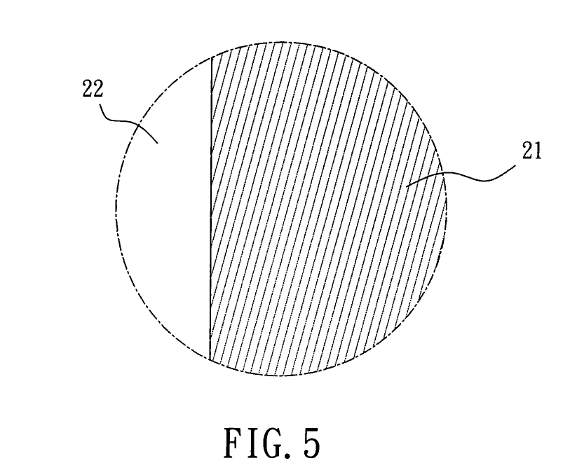

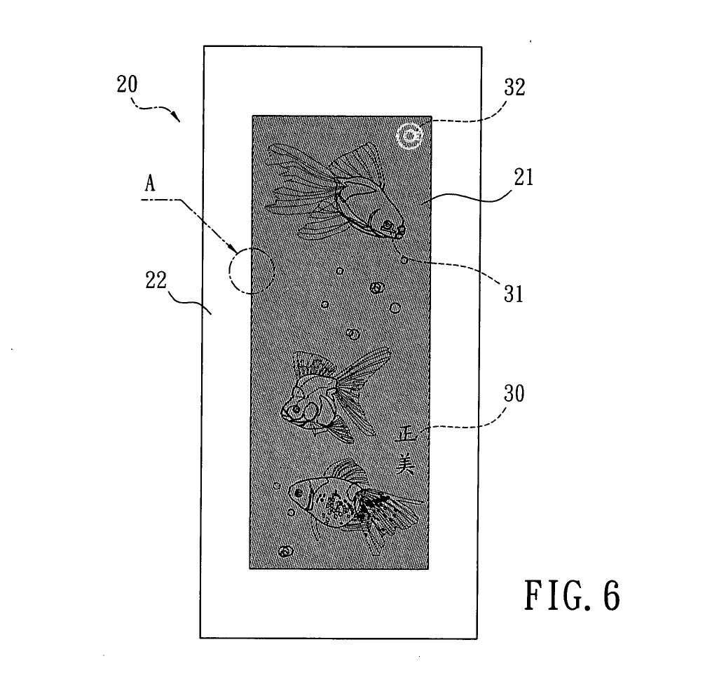

Please refer to FIG. 4 to FIG. 6, in practical application a tag 30 can be made of anti-counterfeiting product that is formed by the manufacturing method described above. The tag 30 is then pasted upon the packing of a trade article (not shown). In the meanwhile, only a general pattern 31 can be observed from the outward appearance of the tag 30 and the anti-counterfeiting pattern 32 cannot be distinguished from the tag 30. If it is desired to tell a fake from an authentic article, a filter 20 having a size corresponding to that of the tag 30 is simply overlapped on the tag 30 so as to show the anti-counterfeiting pattern 32 located inside the tag 30 for counterfeit telling to increase its security.

The filter 20 described above is a rectangular frame having a size the same as that of the singly selected color plate of the design pattern file. The rectangular frame is filled with a plurality of straight lines 21 that are arranged parallel to each other in equal distance according to a filling angle, wherein the filling angle of the straight lines 21 is located corresponding to a dot angle of the color plate. An extended part 22 is located on an outer edge of the rectangular frame of the filter 20, which is filled with the straight lines 21, so that users are enable to hold it for surveying. The filter 20 is therefore constituted.

According to the method described above, every kind of anti-counterfeiting pattern can be applied to the embossed pattern line deforming treatment to form the anti-counterfeiting product that is unidentifiable by naked eyes so as to be provided with excellent anti-counterfeiting effect.

Therefore, as is understood by a person skilled in the art, the present invention achieves the aforementioned purpose according to the above description and satisfies requirements of patent law. The patent application is therefore submitted.

The foregoing preferred embodiments are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

1. A method of making hidden patterns and characters, comprising the following steps of:
a. finishing an original document after a printing design is formed;
b. transforming the printed original document into a digital document; and
c. performing an anti-counterfeiting treatment on the digital document;
c-1. single-selecting a color plate from a design pattern file of the digital document;
c-2. forming a filter file of the digital document: providing a rectangular frame with a size equal to that of the color plate selected singly from the design pattern file, and filling the rectangular frame with a plurality of straight lines that are arranged parallel to each other in equal distance according to a filling angle corresponded to a dot angle of the color plate so as to constitute the filter file;
c-3. performing a graphic arts lining treatment: aligning and overlapping the filter file and the selected color plate and performing a step of graphic arts function calculating, wherein a pattern of the color plate with a darkness/lightness ratio is transformed into a linear filling pattern with a corresponding thickness/thinness ratio;
c-4. performing an embossed pattern line deforming treatment on an anti-counterfeiting pattern: placing the anti-counterfeiting pattern on the linear filling pattern and performing an embossing treatment, wherein an angle/shift deformation is formed on an overlapped line between the linear filling pattern and the anti-counterfeiting product.

2. The method of making hidden patterns and characters according to claim 1, wherein the anti-counterfeiting product is an anti-counterfeiting color plate, the anti-counterfeiting color plate is combined with other color plate(s) of the design pattern file to accomplish the colorful anti-counterfeiting product.

3. The method of making hidden patterns and characters according to claim 1, wherein the anti-counterfeiting product is formed by performing a plate exposure step, a plate washing step, and an on-line printing step sequentially.

4. The method of making hidden patterns and characters according to claim 1, wherein the anti-counterfeiting product is formed by performing a plate exposure step, a plate washing step, and an on-line printing step sequentially.
